(19) United States
(12) Patent Application Publication
(10) Pub. No.: US 2024/0246312 A1
(43) Pub. Date: Jul. 25, 2024

(54) DIMENSIONALLY ADJUSTABLE PLASTIC BAG FEEDER WITH HEAT SEALER AND CUTTER

(71) Applicants: Yiqing ZHENG, Tokyo (JP); Miho TAKAHASHI, Saitama Pref (JP); Ayaka ISHIDA, Chiba Pref. (JP); Kanako UEMATSU, Chiba Pref (JP); Yuna SHIOTANI, Chiba Pref (JP); Hiroki MIYAGAWA, Kanagawa Pref. (JP); Naoto MORI, Tokyo (JP); Iori YAMAZAKI, Chiba Pref. (JP); Ren WATANABE, Tokyo (JP); Tomohiro UONO, Chiba Pref (JP)

(72) Inventors: Yiqing ZHENG, Tokyo (JP); Miho TAKAHASHI, Saitama Pref (JP); Ayaka ISHIDA, Chiba Pref. (JP); Kanako UEMATSU, Chiba Pref (JP); Yuna SHIOTANI, Chiba Pref (JP); Hiroki MIYAGAWA, Kanagawa Pref. (JP); Naoto MORI, Tokyo (JP); Iori YAMAZAKI, Chiba Pref. (JP); Ren WATANABE, Tokyo (JP); Tomohiro UONO, Chiba Pref (JP)

(21) Appl. No.: 18/586,601

(22) Filed: Feb. 26, 2024

(51) Int. Cl. B31B 70/64; B31B 70/16; B31B 70/88; B31B 155/00

(52) U.S. Cl. CPC B31B 70/64; B31B 70/16; B31B 70/88; B31B 2155/00

(57) ABSTRACT

A dimensionally adjustable plastic bag feeder includes a main box whose top surface is open, including a front face having a recess, and first and second side faces, the main box having upper face; a heat sealer formed within the recess; a handle formed on the first side face; a moveable top cover for covering the top surface of the main box, the cover including an elongated convex at its one end and a cutter, which is located near the convex, and the cover being connected to the main box at its another end; and a printer formed on the second side face, the printer including a lever, a printhead and a dial having a plurality of reels, each of which has multiple digits, respectively, wherein the printhead is moved down by pulling down the lever for printing information shown by the dial.

### BACKGROUND OF THE INVENTION

### 1. Field of the Invention

This invention has been made by the members of MIMURA Seminar, College of Law, Nihon, Univ. as a team. The present invention relates to a plastic bag feeder, and more particularly to a plastic bag feeder having a heat sealer, a cutter, and a printer, which enables the supply of plastic bags of any size, and enables the management of the expiration dates for food that may be stored in plastic bags.

### 2. Description of the Related Art

Conventionally, it has been known that the device applies heat to the plastic bag for sealing it, and then cut it. Such a device includes a sealer having a crimping lever and an exposed heat wire. According to the conventional device, by placing a plastic bag between the heat wire and the crimping lever, heat was transferred and the plastic bag was partially weld. The device having such a structure took about 15 seconds from the time it is turned on until for the heat wire is completely hot, and the time required for crimping is approximately 3 seconds. Additionally, the heat wire remained hot for a while after turning off the power, so that it may cause burns to users. Further, since the sealer itself was also exposed, it may cause injury to the users.

Due to the reasons mentioned above, subsequently, plastic bag feeders became the mainstream, which do not have a sealing function, but instead have a pre-sealing treatment to the plastic material and have dashed lines cut into the plastic bag itself at regular intervals, which the user can tear off manually. However, according to the feeder described above, it could only be cut into predetermined sizes, so that it is impossible to cut off the plastic bag into the desired size.

Furthermore, according to the conventional devices described above, the plastic bag detached from the plastic material have no information such as the production date, expiration date, and best before date of the food to be contained therein. This posed a problem as it required additional effort to write the information of the food after the food is stored in the plastic bag.

### SUMMARY OF THE INVENTION

The objective of the present invention is to solve the above described problems and provide a dimensionally adjustable plastic bag feeder including a main box whose top surface is open, including a front face having a recess, and first and second side faces, the main box having upper face; a heat sealer formed within the recess; a handle formed on the first side face; a moveable top cover for covering the top surface of the main box, the cover including an elongated convex at its one end and a cutter, which is located near the convex, and the cover being connected to the main box at its another end; and a printer formed on the second side face, the printer including a lever, a printhead and a dial having a plurality of reels, each of which has multiple digits, respectively, wherein the printhead is moved down by pulling down the lever for printing information shown by the dial.

### BRIEF DESCRIPTION OF THE DRAWINGS

The invention will be more specifically described with reference to the accompanying drawings, in which:

FIG. 1 shows a perspective view of a plastic bag feeder of the present invention;

FIG. 2 shows a cross-sectional side view of a region around a heat sealer illustrated in FIG. 1;

FIG. 3 is a perspective view of a handle illustrated in FIG. 1;

FIG. 4 shows a front view of a printer illustrated in FIG. 1; and

FIG. 5 shows a side view of the printer illustrated in FIG. 4.

### DETAILED DESCRIPTION OF THE PREFERRED EMBODIMENT

A preferred embodiment of the present invention for a dental flossed toothbrush (hereinafter referred to as toothbrush) is described with reference to the drawings as follows. In each drawing, the same reference numerals refer to the same or similar parts throughout all embodiments.

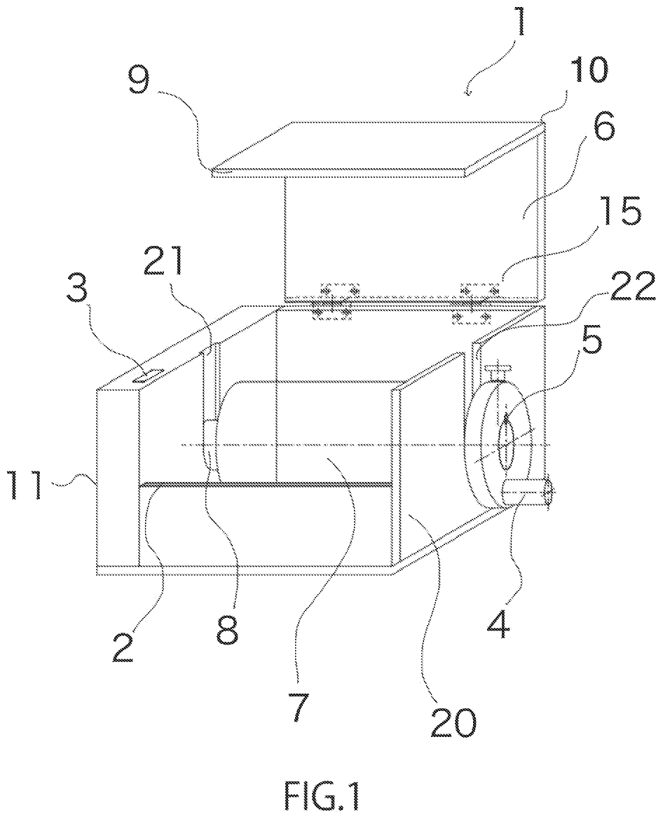

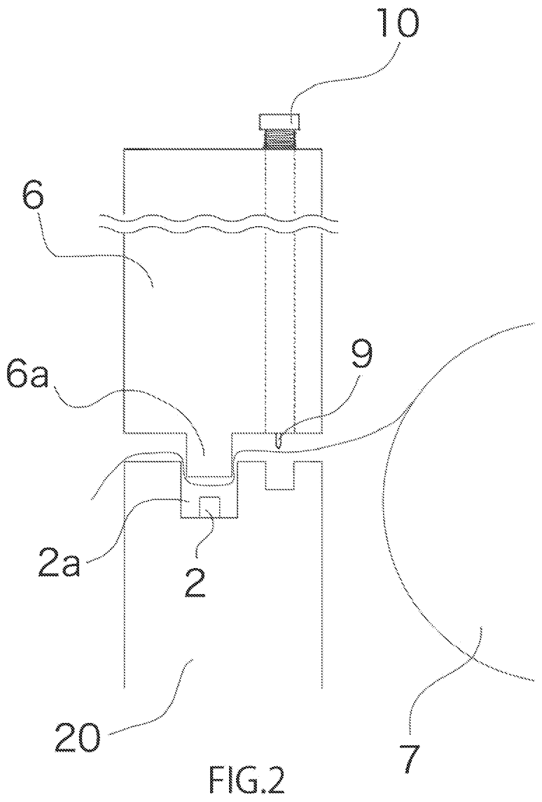

FIG. 1 shows a perspective view of a plastic bag feeder 1 of the present invention, and the plastic bag feeder 1 includes a main box 20, a heat sealer 2, which is located within an elongated recess 2a being formed in a front face of the main body box 20 (as referred in FIG. 2), a switch 3, which is powered by batteries or power from an electrical outlet, for operating the heat sealer 2, a handle 4 for delivering a plastic bag roll 7 placed in the main box 20, a moveable top cover 6 having a cutter 9 and an elongated convex 6a at its one end and being connected to the main box 20 by hinges 15, and a printer 11 capable of printing expiration dates on a surface of a plastic bag. The top cover 6 has a cutter knob 10, which is connected to the cutter 9 so that the cutter 9 moves left or right by moving the cutter knob 10. As shown in FIG. 2, when the top cover 6 closes the main box 20, the cutter 9 is arranged to be located near the heat sealer 2. An elongated convex 6a of the top cover 6 is designed to engage with the elongated recess 2a provided on a front face of the main box 20.

As mentioned above, the plastic bag roll 7 having a core 8 at its center is placed in the main box 20. The main box 20 includes a first notch 21 on one side face and a second notch 22 on another side face opposite to the side face where the first notch 21 is formed, and the core 8 is placed in a rotatable position by engaging with these notches 21, 22.

The top cover 6 is movable, as described above, and can open and close the upper part of the main box 20, the plastic bag 7 placed in the main box 20 can be replaced with the core 8.

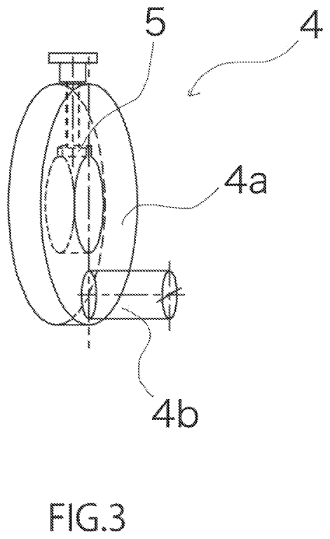

FIG. 3 is a perspective view of the handle 4 illustrated in FIG. 1. The handle 4 includes a large cylinder 4a and a small cylinder 4b. The small cylinder 4b and the large cylinder 4a are connected to each other, so when the small cylinder 4b is manually rotated, the large cylinder 4a is also rotated. The large cylinder 4a is a doughnut-like shaped, and has a key dent 5 formed on its inner side. The core 8 of the plastic bag includes a projection part on its surface at one end, which may be coupled with the key dent 5, and when the handle 4 is rotated by engaging the projecting part with a key groove 5, the plastic bag roll 7 is also rotated because its power applied to the handle 4 is transmitted to the core 8.

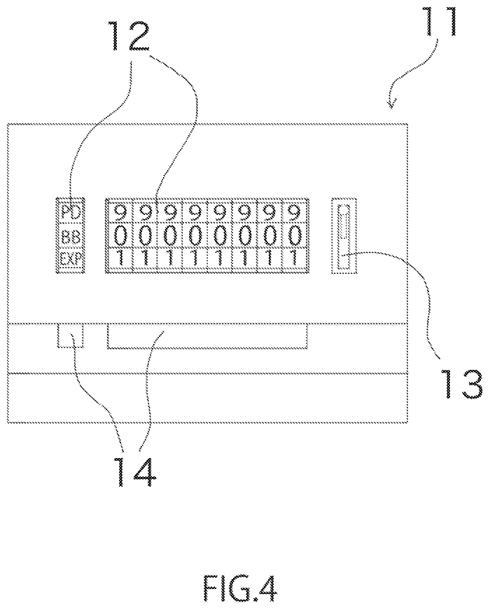

As shown in FIG. 4, the printer 11 has a dial 12, a printing lever 13, and a printhead 14. The dial 12 has a numeric section and an explanatory section, and the explanatory section can select one of information, such as production date (referred as PD), a best-before date (BB) and an expiration date (EXP). The numeric section has eight reels, each of which the number starts from zero (0) to nine (9), respectively, and the first four reels means “year”, the fifth to sixth reel means “month” and the last two reel means “day”, and user of the printer 11 can display the date by moving the reels. The dial 12 is electrically connected to the printhead 14 so that the displayed information at the numeric section and the explanatory section may be transmitted to the printhead 14. The printing lever 13 is connected to the printhead 14 so that the printhead 14 is moved down by pressing down the printing lever 13. The plastic bag roll 7 is a roll of, two thin plastic films, with both sides sealed.

Next, the use of the plastic bag feeder 1 is described below. As shown in FIG. 1, first, the plastic bag roll 7 having the core 8 is placed in the main box 20. After that, the end of the thin films of the plastic bag roll 7 is gripped and pulled up to a desired length, while simultaneously rotating the handle 4. Then, the user stores the products into the thin films of the plastic bag roll 7. Next, the main box 20 is closed with the cover 6 as shown in FIG. 2. After that, the heat sealer 2 and the printer 11 become ready for operation by turning on the switch 3. In such a state, when the cover 6 is pressed down further, the elongated convex 6a formed in the cover 6 inserts into the recess 2a formed in the main body box 20, and the elongated convex 6a of the cover 6 presses down the thin films drawn out from a plastic bag roll 7 to the heat sealer 2 for 3 seconds at 200 degree whereby the thin plastic films are welded to each other. After welded, the thin plastic films are detached from the plastic roll 7 by the cutter 9, which is manipulated by pressing and sliding the cutter knob 10, whereby an individual and desirable sized plastic bag is formed.

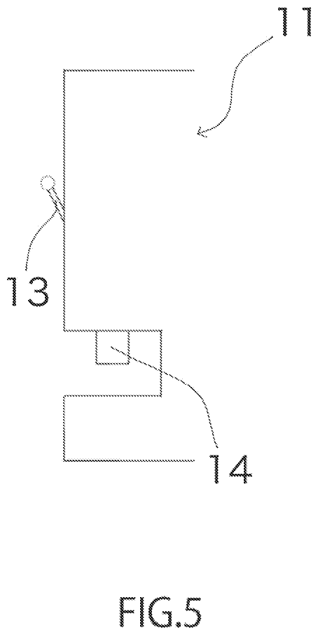

Further, by placing a portion of the detached plastic back under the printhead 14 shown in FIGS. 4 and 5, then setting the digits in the dial 12 and pressing the printing lever 13, the information set by the dial 4 is printed on the surface of the plastic bag.

According to the plastic bag feeder 1 having the structure described above, the heat sealer 2 can weld the thin plastic films at desired size and cut. Further, as shown in FIG. 5, it is possible to print the information of the product stored in the plastic bag on the surface of the plastic bag. Moreover, as shown in FIG. 3, since the heat sealer 2 is installed in the recess 2a, which is formed in the front face of the main box 20, so that a user can safely use the plastic bag feeder 1 of this invention because the heat sealer is not exposed, compared with the conventional device.

While the invention has been described with reference to illustrative embodiments, this description is not intended to be construed in a limiting sense. Thus, shapes, size and physical relationship of each component are roughly illustrated so the scope of the invention should not be construed to be limited to them. Further, to clarify the components of the invention, hatching is partially omitted in the cross-sectional views. Moreover, the numerical description in the embodiment described above is one of the preferred examples in the preferred embodiment so that the scope of the invention should not be construed to limit to them.

Various other modifications of the illustrated embodiment will be apparent to those skilled in the art on reference to this description. Therefore, the appended claims are intended to cover any such modifications or embodiments as fall within the true scope of the invention.

We claim:

1. A plastic bag feeder, comprising:
a main box whose top surface is open, including a front face having a recess, and first and second side faces, the main box having upper face;
a heat sealer formed within the recess;
a handle formed on the first side face;
a moveable top cover for covering the top surface of the main box, the cover including an elongated convex at its one end and a cutter, which is located near the convex, and the cover being connected to the main box at its another end; and
a printer formed on the second side face, the printer including a lever, a printhead and a dial having a plurality of reels, each of which has multiple digits, respectively, wherein the printhead is moved down by pulling down the lever for printing information shown by the dial.

2. A plastic bag feeder, according to claim 1, wherein the handle includes a key dent, further comprising:
a plastic bag roll; and
a core formed in the center of the plastic bag roll, the core having a projection part, which is formed at its one end wherein the projection part is couple with the key dent when the plastic bag roll is placed in the main box,
whereby the movement of the handle and plastic bag roll are interlocked vis the core.
